(19) United States
(12) Patent Application Publication
(10) Pub. No.: US 2018/0314318 A1
(43) Pub. Date: Nov. 1, 2018

(54) POWER SUPPLY AND SERVER FOR PERFORMING A VIRTUAL RESEAT

(71) Applicant: Lenovo Enterprise Solutions (Singapore) Pte. Ltd., Singapore (SG)

(72) Inventors: Luke D. Remis, Raleigh, NC (US); Douglas I. Evans, Cary, NC (US); Brian C. Totten, Durham, NC (US)

(21) Appl. No.: 15/499,976

(22) Filed: Apr. 28, 2017

(51) Int. Cl. G06F 1/32; H02M 7/04; G06F 1/26; G06F 9/44

(52) U.S. Cl. CPC G06F 1/3296; H02M 7/04; G06F 1/26; G06F 1/263; G06F 1/3212; G06F 9/442; G06F 1/3287

(57) ABSTRACT

A power supply and a server are disclosed. The power supply includes a voltage regulator (VR) and a control circuit (CC). The CC monitors the voltage on a power output of the VR, and enables the VR to supply power to the power output in response to the voltage on the power output being less than a threshold voltage level. The CC receives power from a power source even after the VR has been disabled. A server may include the power supply and the CC, as well as a CPU for executing an operating system (OS) and a baseboard management module for receive a virtual reseat request (VRR), request shutdown of the operating system in response to the VRR, enable the CC in response to the VRR, determine whether the OS has shut down, and disable the power supply in response to determining the OS has shut down.

### BACKGROUND

The present disclosure relates to an apparatus for disabling and enabling a power supply or a server without requiring a physical disconnection from a power source.

### BACKGROUND OF THE RELATED ART

A data center is a facility that houses and supports a large number of computer systems, network devices and supporting infrastructure. Data centers are often setup to be “lights out” environments, which means that the data center is administered by remote personnel and there may not be any datacenter personnel on site. However, a server can sometimes become unresponsive, such that it is necessary to power cycle the server. An unresponsive server is typically power cycled by physically disconnecting and then reconnecting the server from its power source. For example, this may involve temporarily unplugging one or more power cords from the back of the server, or temporarily unplugging one or more power cords from a power distribution unit. In the case of a blade server, the unresponsive server may be physically removed from, and then reinstalled into, a multi-blade chassis. In the case of a rack server, the rack server may receive power from an external Ethernet-based power strip that can be remotely operated to switch power off and on.

### BRIEF SUMMARY

One embodiment provides a power supply comprising a voltage regulator and a control circuit. The voltage regulator has a power input, a power output, and an input for disabling the voltage regulator. The control circuit has a first input for monitoring the voltage on the power output of the voltage regulator, and an output for enabling the voltage regulator to supply power to the power output, wherein the control circuit receives power from a power source that provides power for a period of time after the voltage regulator has been disabled, and wherein the control circuit enables the voltage regulator to supply power to the power output in response to the voltage on the power output being less than a threshold voltage level indicating that the voltage regulator has been disabled.

Another embodiment provides a server comprising a power supply, a control circuit, a central processing unit and a baseboard management module. The power supply includes a voltage regulator, the voltage regulator having a power input and a power output for providing power to a plurality of server components. The control circuit is for monitoring the voltage regulator and for enabling the voltage regulator in response to determining that the voltage regulator has been disabled. The central processing unit is provided for executing an operating system. The baseboard management controller is provided for monitoring the central processing unit and controlling the power supply, wherein the baseboard management controller is in communication with at least one storage device for storing program instructions and includes a processor for processing the program instructions to: receive a request for a virtual reseat of the server, request shutdown of the operating system in response to receiving the virtual reseat request, enable the control circuit in response to receiving the virtual reseat request, determine whether the operating system has shut down, and disable the voltage regulator in response to determining that the operating system has shut down subsequent to receiving the virtual reseat request.

### BRIEF DESCRIPTION OF THE SEVERAL VIEWS OF THE DRAWINGS

FIG. 1 is a diagram of a server according to one embodiment.

FIG. 2 is a diagram of the server of FIG. 1 with the control circuit receiving power from a battery rather than an AC/DC converter.

FIG. 3 is a diagram of the server of FIG. 2 with two power supplies and a control circuit operatively coupled to the two power supplies.

FIG. 4 provides a flowchart of a method according to another embodiment.

### DETAILED DESCRIPTION

One embodiment provides a power supply comprising a voltage regulator and a control circuit. The voltage regulator has a power input, a direct current (DC) power output, and an input for disabling the voltage regulator. The control circuit has a first input for monitoring the voltage on the power output of the voltage regulator, and an output for enabling the voltage regulator to supply power to the power output, wherein the control circuit receives power from a power source that provides power for a period of time after the voltage regulator has been disabled, and wherein the control circuit enables the voltage regulator to supply power to the power output in response to the voltage on the power output being less than a threshold voltage level indicating that the voltage regulator has been disabled.

When the power supply is in use, the power input of the voltage regulator will be connected to a power source, such as a power distribution unit (PDU), to receive alternating current (AC). The voltage regulator converts the alternating current into direct current (DC), which is provided as DC power output at one or more voltages. A power supply for a typical server may, for example, provide DC power output at multiple voltages, such as +3.3V, +5V, +12V and −12V. The power supply may further include one or more input for receiving a disable signal or an enable signal. In one embodiment, the power supply includes a disable input for receiving a disable signal from a baseboard management controller and an enable input for receiving an enable signal from the control circuit. Alternatively, a single input may receive both the disable signal and the enable signal. The control circuit may be implemented as an analog circuit, digital circuit (such as an integrated circuit), or a combination thereof.

In one option, the control circuit may include an input for receiving an enable signal from the baseboard management controller, wherein the control circuit is able to turn on the voltage regulator only after receiving the enable signal from the baseboard management controller. The control circuit is preferably only enabled in response to an instruction from the baseboard management controller. Furthermore, the control circuit may be disabled by the baseboard management controller, or the control circuit may disable itself, subsequent to the control circuit enabling the voltage regulator.

The power source for the control circuit may be selected from a battery, a capacitor, and an AC/DC converter. The battery or capacitor may be charged by the DC power output from the voltage regulator prior to the voltage regulator being disabled. Accordingly, the battery or capacitor may provide DC power to the control circuit even after the voltage regulator has been disabled. Alternatively, the power source may be an AC/DC converter that is connected to an AC power source independent of the voltage regulator. While the control circuit and the voltage regulator may be connected to the same AC power source, the control circuit may continue to receive DC power from its AC/DC converter after the voltage regulator has been disabled.

As stated before, the control circuit enables the voltage regulator to supply power to the power output in response to the voltage on the power output being less than a threshold voltage level indicating that the voltage regulator has been disabled. In one embodiment, the control circuit enables the voltage regulator to supply power to the power output in response to the monitored voltage on the power output being less than the threshold voltage level (such as less than 2 Volts) for more than a threshold amount of time (such as more than 0.5 seconds).

Another embodiment provides a server comprising a power supply, a control circuit, a central processing unit and a baseboard management module. The power supply includes a voltage regulator, the voltage regulator having a power input and a power output for providing power to a plurality of server components. The control circuit is for monitoring the voltage regulator and for enabling the voltage regulator in response to determining that the voltage regulator has been disabled. The central processing unit is provided for executing an operating system. The baseboard management controller is provided for monitoring the central processing unit and controlling the power supply, wherein the baseboard management controller is in communication with at least one storage device for storing program instructions and includes a processor for processing the program instructions to: receive a request for a virtual reseat of the server, request shutdown of the operating system in response to receiving the virtual reseat request, enable the control circuit in response to receiving the virtual reseat request, determine whether the operating system has shut down, and disable the voltage regulator in response to determining that the operating system has shut down subsequent to receiving the virtual reseat request.

The server may have various form factors, such as a rack mount server, and may have various component configurations, such as a server with multiple central processing units and multiple power supplies. In one option, the server may have multiple power supplies, with each power supply have its own control circuit. In another option, the server may have multiple power supplies and a single control circuit that is able to monitor the power output of the voltage regulator in each power supply and enable the voltage regulator in each power supply.

The control circuit may have a first input for monitoring the voltage on the power output of the voltage regulator and an output for enabling the voltage regulator to supply power to the power output, wherein the control circuit receives power from a power source that provides power for a period of time after the voltage regulator has been disabled, and wherein the control circuit enables the voltage regulator to supply power to the power output in response to the monitored voltage on the power output being less than a threshold voltage level indicating that the voltage regulator has been disabled.

Embodiments of the server may perform a virtual reseat, which may also be referred to as “self-power cycling.” The term ‘reseat’ is known and used in connection with the use of server blades to indicate the action of physically removing (disconnecting) the server blade from a multi-blade chassis that provides power to the server blade, and then reseating (reconnecting) the server blade with the effect of power cycling the server blade. The term “virtual reseat” is used herein to mean that a server is power cycled while the server remains coupled to an AC power source. Accordingly, a virtual reseat of the server may be performed without requiring the presence of a user since there is no need to physically disconnect/reconnect the server from a power source.

The virtual reseat request may be received by the baseboard management controller from various sources. In one example, the server may include a front panel display and/or a front panel power button. Accordingly, the virtual reseat request may be received from a front panel power button or a front panel display input of the server. In another example, the server may include a basic input/output system, wherein the virtual reseat request may be received from the basic input/output system. Optionally, the basic input/output system may issue the virtual reseat request in response to downloading a firmware update or a change in one or more user settings. In yet another example, the virtual reseat request may be received from a remote client computer via a network. The virtual reseat request may, without limitation, be received as a command using an Intelligent Platform Management Interface specification. Furthermore, the remote client computer may trigger the virtual reseat request using a BMC webpage.

After the baseboard management controller has received the virtual reseat request, the baseboard management controller may request shutdown of the operating system. For example, the baseboard management controller may request shutdown of the operating system by asserting a power button signal. The power button signal may be the same signal as is generated in response to a manual actuation of a front panel power button. Separately, the baseboard management controller may determine whether the operating system has shut down by monitoring checkpoints or progress codes that the baseboard management controller receives from the basic input/output system or the operating system. For example, the baseboard management controller may wait for the operating system to enter a sleep state prior to disabling the power supply. Accordingly, if the server is running in the operating system (OS) and is offloading data to non-volatile memory (NVMe) cache, then the system baseboard management controller may wait for completion of those tasks and confirmation that the OS has shut down before disabling the power supply(ies). As used herein, references to “disabling the power supply(ies)” may be used interchangeably with references to “disabling the voltage regulator(s)”, and similar phrases. Furthermore, each power supply can have multiple voltage regulators. In a further option, the baseboard management controller may disable the power supply if the operating system does not enter a sleep state within a predetermined time period following the request for the operating system to shut down.

After the baseboard management controller has disabled the voltage regulator and the control circuit has subsequently enabled the voltage regulator, the server will reboot in response to the plurality of server components receiving power from the power output of the voltage regulator. Optionally, the control circuit may be disabled after the control circuit has enabled the power supply.

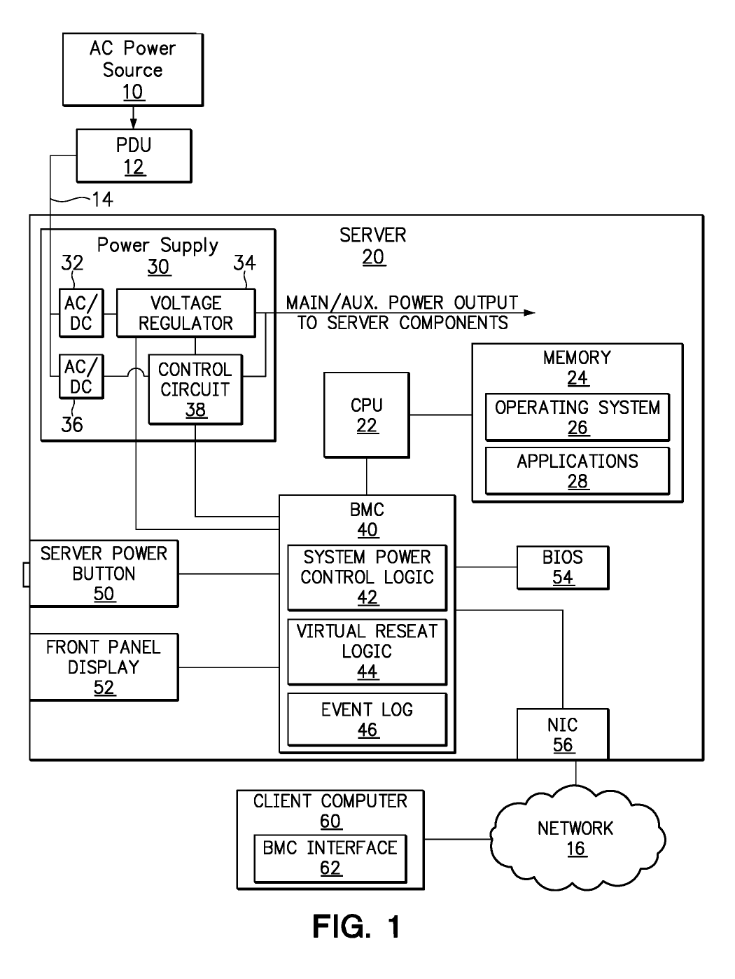

FIG. 1 is a diagram of a server 20 according to one embodiment. The server 20 includes a power supply 30 that receives AC power from an AC power source 10 through a power distribution unit (PDU) 12. The power supply includes an AC to DC converter (AC/DC converter) 32 that converts the alternating current (AC) to direct current (DC) and a voltage regulator 34 that regulates the voltage on one or more power outputs to the server components. Optionally, the voltage regulator may incorporate the AC/DC converter. The power supply 30 also includes a second AC/DC converter 36 that serves as a power source to the control circuit 38. The second AC/DC converter 36 provides power to the control circuit 38, such that the control circuit 38 does not rely upon the voltage regulator 34 for power.

The server 20 further includes a central processing unit 22 and memory 24 in communication with the central processing unit. The memory 24 may store an operating system 26, and will typically also store one or more application programs 28, that may be executed by the central processing unit 22.

In addition, the server 20 includes a baseboard management controller (BMC) 40 operatively coupled for communication with both the central processing unit 22 and the power supply 30. In particular, the BMC 40 may monitor the CPU 22 to determine whether the CPU is currently executing the operating system or is in a sleep state. For example, the BMC may receive progress codes and operating state updates from the CPU. The BMC 40 may also provide power control signals to the voltage regulator 34 and the control circuit 38. In one embodiment, the BMC 40 may disable the voltage regulator 34 and enable the control circuit 38 in response to determining that the CPU is in a sleep state.

The BMC 40 is a service processor that may execute program instructions stored in memory associated with the BMC. In one embodiment, the BMC executes program instructions to perform system power control logic 42, perform virtual reseat logic 44, and interface with an event log 46. For example, the system power control logic 42 may be used to control communications with the voltage regulator 34, such as monitoring power output and temperature of the voltage regulator, as well as enabling/disabling the voltage regulator. The virtual reseat logic 44 may be used to initiate a virtual reseat of the server, and the event log 46 stores a log of events occurring in the server such as the initiation of a virtual reseat operation.

The server 20 includes a server power on/off button 50, a front panel display 52 such as a touchscreen, a basic input/output system (BIOS) 54, and a network interface controller (NIC) 56. As previously discussed, the server power on/off button 50 may be used to manually turn the server on or off, and the front panel display 52 may be used to manually enter a virtual reseat request. While manually entering a virtual reseat request requires on site personnel, the virtual reseat request eliminates the need for the personnel to locate and physically disconnect the power cable 14 that supplies alternating current to the server 20. Optionally, the BIOS 54 may send a virtual reseat request to the BMC 40, for example to cause a reboot of the server after downloading a firmware update or detecting a change in one or more user settings. A BIOS-triggered virtual reseat may lead to quicker implementation of a firmware update. Still further, the BMC 40 may receive a virtual reseat request from a remote client computer 60 that communicates with the NIC 56 via a network 16. The remote client computer 60 may be operated by authorized data center personnel and may use a BMC interface 62, such as a BMC webpage displayed in a web browser application. In this case, the virtual reseat request may be sent from the client computer over the network using the Intelligent Platform Management Interface (IPMI) specification to communicate with the BMC 40. While IPMI does not offer a native “virtual reseat” command, embodiments may use a raw or unused IPMI command that the baseboard management controller is programmed to decode as a virtual reseat.

The remote client computer 60 may issue the virtual reseat request by using a BMC webpage that is accessible at a known Internet Protocol (IP) address, wherein the BMC webpage implements a new feature that allows authorized personnel to remotely trigger a virtual reseat request. The BMC webpage may also display information related to one or more servers, such as the server status and operating data, which may assist the user in determining whether or not to assert a virtual reseat request for a particular server. Specifically, the BMC webpage may display data or alarms indicating the a particular server is experiencing a problem and may include a virtual button that can be selected with a pointing device in order to initiate a virtual reseat request for the particular server.

When the baseboard management controller 40 receives a virtual reseat request, the baseboard management controller preferably stores an entry in a system event log 46 to document that the virtual reseat was requested. Accordingly, personnel can later determine why the server was power cycled, such as by identifying the origin of the virtual reseat request.

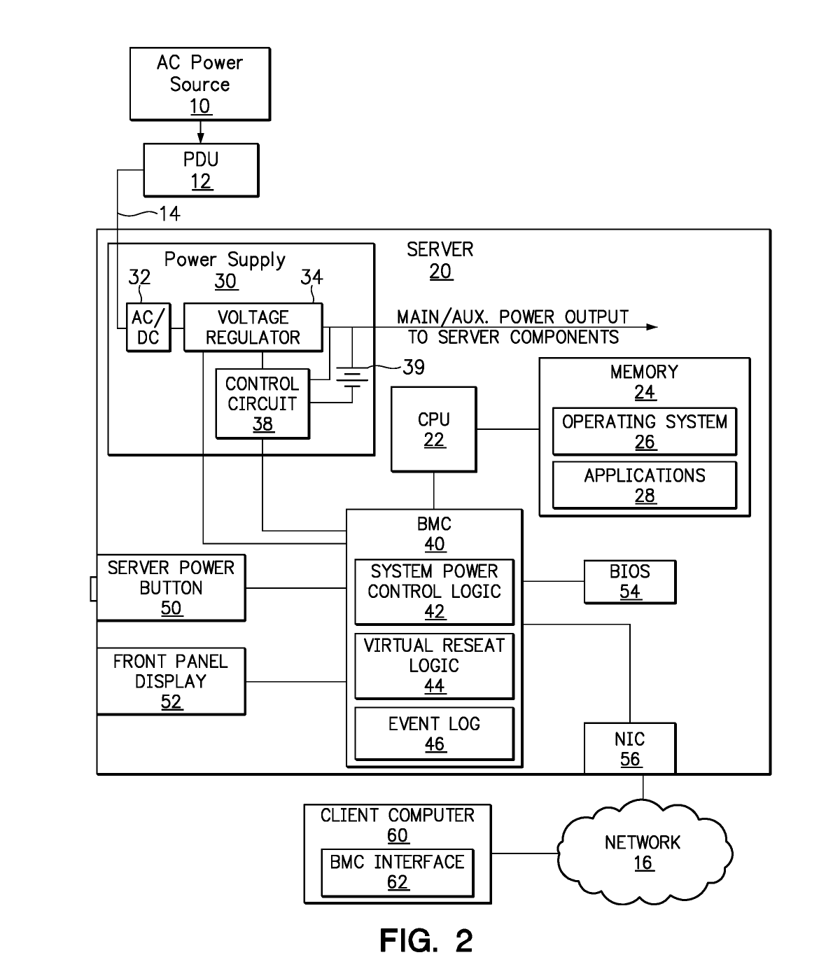

FIG. 2 is a diagram of the server of FIG. 1 with the control circuit 38 receiving power from a battery 39 rather than an AC/DC converter (see the AC/DC converter 36 in FIG. 1). The battery 39 may be charged via a connection to the DC power output of the voltage regulator 34, then provide power to the control circuit 38 for a period of time after the voltage regulator 34 has been disabled.

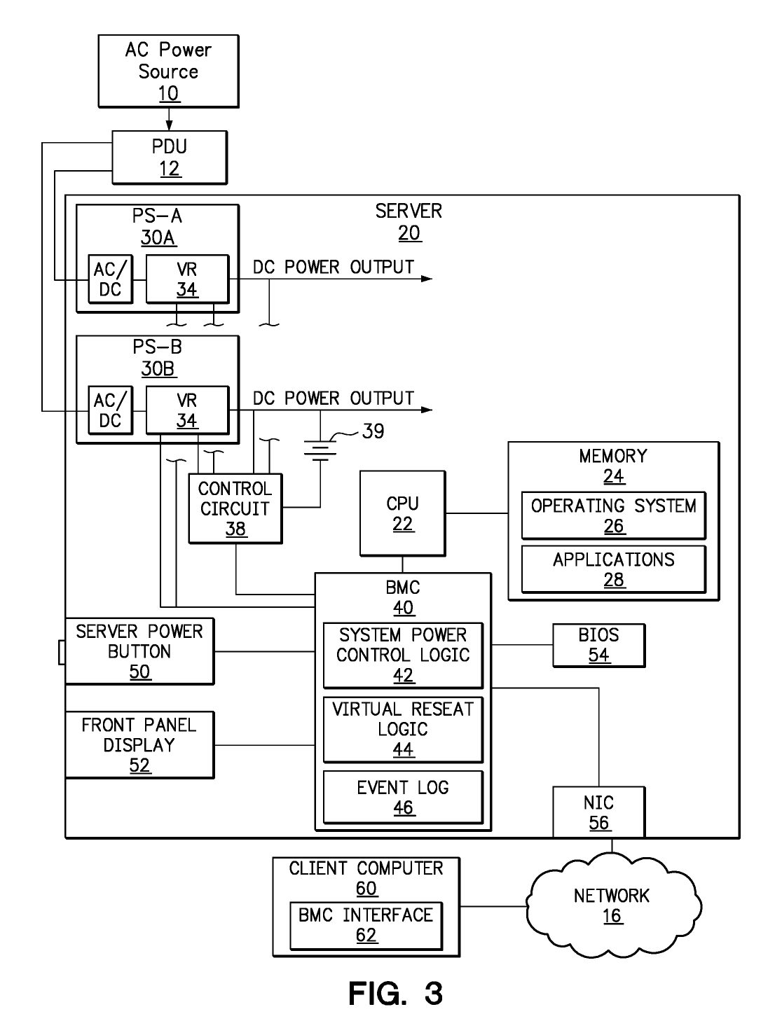

FIG. 3 is a diagram of the server of FIG. 2 with two power supplies 30A, 30B and a control circuit 38 operatively coupled to the two power supplies. The power supplies 30A, 30B and the control circuit 38 operate the same as the power supply and control circuit of FIG. 2, except that the control circuit monitors the power output of both power supplies 30A, 30B and provides an enable signal to the voltage regulators (VR) 34 of the respective power supplies 30A, 30B in response to detecting the voltage of the two power outputs both meet predetermined output conditions. The battery 39 that powers the control circuit 38 may be charged from either of the power outputs. Furthermore, the BMC 40 may provide a disable signal to each voltage regulator 34 in response to receiving a virtual reseat request. The server may include any number of power supplies in a manner similar to that shown in the diagram of FIG. 3. Alternatively, the server may have multiple power supplies that each have their own control circuit consistent with the diagram of FIG. 2.

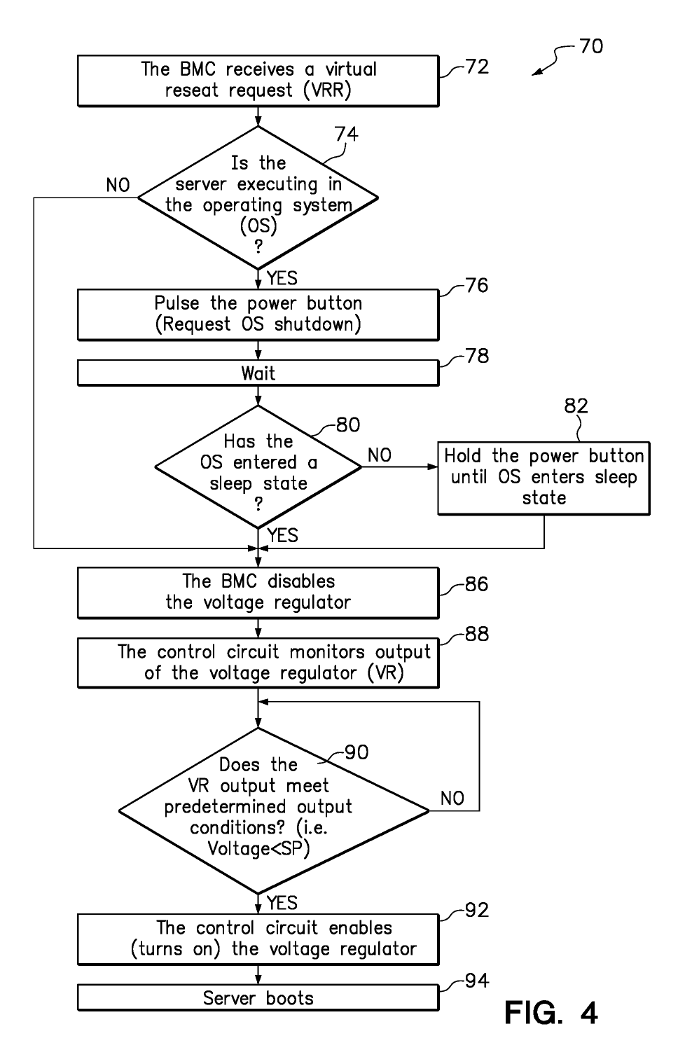

FIG. 4 provides a flowchart of a method 70 according to another embodiment. The following description of the method 70 may include parenthetical references to the elements of the server 20 in FIG. 1.

In step 72, the baseboard management controller (40) may receive a virtual reseat request (VRR). This may cause the BMC (40) to begin executing the virtual reseat logic (44). In step 74, the BMC may determine whether the server (20) is executing the operating system (26). For example, the baseboard management controller may be aware of the server's operating system status based on checkpoints or progress codes that the baseboard management controller (40) receives from the BIOS (54) or the CPU (22).

If the server is executing the operating system (OS), then, in step 76, the baseboard management controller may pulse the power button (i.e., issue a signal as if the power button had been manually pushed) to cause a request for the OS to shut down (i.e., enter the sleep state). If the OS denies the shutdown request (i.e., sleep state request), then the OS will not enter a sleep state. In step 78, the baseboard management controller (40) will preferably wait for the OS to enter a sleep state prior to disabling the power supply (30). For example, the sleep state signal may be an S5 global state according to the Advanced Configuration and Power Interface (ACPI) specification.

In the S5 sleep state, only auxiliary power (AUX) is being provided to the server. Auxiliary power is provided to the BMC and any other management components that may still be in use while the server is off. A server that is powered off may have its power supply(ies) safely disabled. A disabled power supply does not produce any power output, not even auxiliary power (AUX). For example, the baseboard management controller may disable the power supply(ies) output by sending a signal to a GPIO (General Purpose I/O) pin of the power supply(ies), sending a PMBus command, sending an I2C (Inter-Integrated Circuit) command, or sending a command via any type of serial bus.

Optionally, a setting could be implemented that enables the baseboard management controller (40) to force a shutdown. For example, if it is determined, in step 80, that the operating system has not entered a sleep state after the wait in step 78, then the baseboard management controller may hold (assert) the power button, per step 82, until the OS enters the sleep state. The baseboard management controller may hold the power button by asserting a power button (off) signal to the chipset without requiring personnel to take any physical action. Optionally, the baseboard management controller may be responsible for asserting a power button (off) signal to the chipset either in response to the power switch/button (50) sending an output signal to the baseboard management controller due to manual actuation of the power switch/button or in response to the virtual reseat logic (44) detecting that the baseboard management controller has received a virtual reseat requests.

In step 86, after receiving the virtual reseat request and determining that the server has been turned off (sleep state), the baseboard management controller (40) disables the voltage regulator (34).

In step 88, the control circuit (38) monitors the output voltage of the voltage regulator (34). In step 90, it is determined whether the voltage regulator (34) output meets predetermined output conditions, such as the output voltage dropping below a setpoint voltage level. Step 90 may repeat until the output meets predetermined output conditions. In a further option, the predetermined output conditions may include the detected output voltage being less than a threshold voltage for greater than a threshold amount of time (e.g. less than 2 Volts for at least 0.5 seconds).

Once the control circuit (38) detects that the output has met the predetermined output conditions indicating that the voltage regulator has been disabled (per step 90), then the control circuit (38) will enable (turn on) the voltage regulator (34) in step 92. It should be appreciated that the baseboard management controller (40) initiates the virtual reseat and disables the voltage regulator (34), but it is the control circuit (38) that completes the virtual reseat by enabling the voltage regulator (34).

With the voltage regulator (34) enabled and providing power output to the server components (per step 92), the server components will boot or restart in step 94 as if an AC power cycle has occurred (i.e., the BIOS starts, the BMC reboots and the CPU will reload the operating system).

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A power supply, comprising:
a voltage regulator having a power input, a power output, and an input for disabling the power output of the voltage regulator;
a control circuit having a first input for monitoring the voltage on the power output of the voltage regulator, and an output for enabling the voltage regulator to supply power to the power output, wherein the control circuit receives power from a power source that provides power for a period of time after the voltage regulator has been disabled, and wherein the control circuit enables the voltage regulator to supply power to the power output in response to the voltage on the power output being less than a threshold voltage level indicating that the voltage regulator has been disabled.

2. The power supply of claim 1, further comprising:
a second input to the control circuit for receiving an enable signal from a baseboard management controller, wherein the control circuit is able to turn on the voltage regulator only after receiving the enable signal from the baseboard management controller.

3. The power supply of claim 1, wherein the power source for the control circuit is selected from a battery, a capacitor, and an AC/DC converter.

4. The power supply of claim 1, wherein the control circuit enables the voltage regulator to supply power to the power output in response to the monitored voltage on the power output being less than the threshold voltage level for more than a threshold amount of time.

5. A server, comprising:
a power supply including a voltage regulator having a power input and a power output for providing power to a plurality of server components;
a control circuit for monitoring the voltage regulator and for enabling the voltage regulator in response to determining that the voltage regulator has been disabled;
a central processing unit for executing an operating system; and
a baseboard management controller for monitoring the central processing unit and controlling the power supply, wherein the baseboard management controller is in communication with at least one storage device for storing program instructions and includes a processor for processing the program instructions to:
receive a request for a virtual reseat of the server;
request shutdown of the operating system in response to receiving the virtual reseat request;
enable the control circuit in response to receiving the virtual reseat request;
determine whether the operating system has shut down; and
disable the voltage regulator in response to determining that the operating system has shut down subsequent to receiving the virtual reseat request.

6. The server of claim 5, wherein the processor of the baseboard management controller requests shutdown of the operating system by asserting a power button signal.

7. The server of claim 5, wherein the power source for the control circuit is selected from a battery, a capacitor, and an AC/DC converter.

8. The server of claim 5, wherein the control circuit enables the voltage regulator to supply power to the power output in response to the monitored voltage on the power output being less than the threshold voltage level for more than a threshold amount of time.

9. The server of claim 8, wherein the threshold voltage level is less than 2 Volts and the threshold amount of time is at least 0.5 seconds.

10. The server of claim 5, further comprising:
a front panel display, wherein the virtual reseat request is received from a button or front panel display input of the server.

11. The server of claim 5, further comprising:
a basic input/output system, wherein the virtual reseat request is received from the basic input/output system.

12. The server of claim 11, wherein the basic input/output system issues the virtual reseat request in response to completion of a firmware update or a change in one or more user settings.

13. The server of claim 5, wherein the virtual reseat request is received from a remote client computer via a network.

14. The server of claim 13, wherein the virtual reseat request is received as a command using an Intelligent Platform Management Interface specification.

15. The server of claim 13, wherein the remote client computer triggers the virtual reseat request using a BMC webpage.

16. The server of claim 5, wherein the processor of the baseboard management controller determines whether the operating system has shut down by monitoring checkpoints or progress codes that the baseboard management controller receives from the basic input/output system or the operating system.

17. The server of claim 5, wherein the baseboard management controller waits for the operating system to enter a sleep state prior to disabling the power supply.

18. The server of claim 5, wherein the baseboard management controller disables the power supply if the operating system does not enter a sleep state within a predetermined time period following the request for the operating system to shut down.

19. The server of claim 5, wherein the server reboots in response to the plurality of server components receiving power from the power output when the voltage regulator is enabled by the control circuit.

20. The server of claim 5, wherein the control circuit has a first input for monitoring the voltage on the power output of the voltage regulator and an output for enabling the voltage regulator to supply power to the power output, wherein the control circuit receives power from a power source that provides power for a period of time after the voltage regulator has been disabled, and wherein the control circuit enables the voltage regulator to supply power to the power output in response to the monitored voltage on the power output being less than a threshold voltage level indicating that the voltage regulator has been disabled.
